(19) United States
(12) Patent Application Publication
(10) Pub. No.: US 2004/0226803 A1
(43) Pub. Date: Nov. 18, 2004

(54) Transport system for containers, and corner transfer unit for such a transport system

(75) Inventors: Wolfgang Brixius, Neunkirchen (DE); Dominik Grafer, Dortmund-Wellinghofen (DE); Albrecht Hoene, Lappersdorf (DE)

Correspondence Address: HENRY M FEIEREISEN, LLC, 350 FIFTH AVENUE, SUITE 4714, NEW YORK, NY, 10118, US

(73) Assignee: SIEMENS AKTIENGESELLSCHAFT, Munchen (DE)

(21) Appl. No.: 10/816,797

(22) Filed: Apr. 2, 2004

(30) Foreign Application Priority Data
Apr. 4, 2003 (DE) 103 15 403.5

(51) Int. Cl. B65G 47/34

(52) U.S. Cl. 198/370.1; 198/809

(57) ABSTRACT

A transport system for containers includes an infeed conveyor and an ouffeed conveyor at an angle to one another. A corner transfer unit is placed between the infeed and ouffeed conveyors and has a transfer conveyor extending in transport direction of the ouffeed conveyor and defining a transport plane which is lower than the transport plane of the infeed conveyor. An endless conveyor belt is disposed in an area of the transfer conveyor and is provided with a thickened area for compensating a distance between the transport planes of the infeed conveyor and the transfer conveyor to enable a movement of the container from the infeed conveyor onto the transfer conveyor as the container rests on the thickened area. Maintaining the container above the transport plane of the transfer conveyor as the container leaves the infeed conveyor is a support element to thereby lower the container to a level of the transport plane of the transfer conveyor, when the thickened area moves downwards in synchronism with a downward movement of the support element.

### CROSS-REFERENCES TO RELATED APPLICATIONS

This application claims the priority of German Patent Application, Serial No. 103 15 403.5, filed Apr. 4, 2003, pursuant to 35 U.S.C. 119(a)-(d), the disclosure of which is incorporated herein by reference.

### BACKGROUND OF THE INVENTION

The present invention relates, in general, to a transport system for transport of containers, in particular to an airport baggage handling system, and more particularly to a corner transfer unit for use in such a transport system.

Transport systems are generally known by which articles, such as containers or trays, travel along a transport path comprised of interconnected single conveyors. Oftentimes the transport path requires an arrangement of immediately following conveyors at an angle. When the angle between the following conveyors is 90°, a so called “corner transfer unit” is provided. An example of a conventional corner transfer unit is described in German Pat. No. DE 197 25 480 C1. The corner transfer unit places hereby the containers exiting an infeed conveyor in transport direction of an ouffeed container. Both, infeed and ouffeed containers are disposed in spaced-apart horizontal planes, whereby a lifting platform is used for compensating a vertical distance between the planes. Lifting platforms of this type can be utilized in conveyors with roller conveyors or belt conveyors.

In order to realize the three functions, infeed, lifting, and outfeed, three drives are normally used. A first drive conveys the container to a position that allows a transfer rectangular to the incoming transport direction. The container is halted at this position and elevated from the infeed conveyor by a lifting gear which is operated by a second drive. A third drive is activated in this position of the container to move the ouffeed conveyor for transporting the container further transport direction.

It is also known to construct a corner transfer unit with two parallel conveyor belts disposed at an angle of 90° in relation to a main transport direction, with each of the conveyor belts carrying a wedge connected to the belt. When moved out of the main transport direction, the container travels to a position in which both wedges are guided under the trailing container edge in movement direction. Movement back into the main transport direction is also implemented by both wedges which grasp the leading edge of the container and draw the container against a stop by which the container is kept in place until the wedges dive down underneath the container via respective deflection rollers.

It would be desirable and advantageous to provide an improved transport system which obviates prior art shortcomings and is constructed with a corner transfer unit by which the containers can be transferred in substantial horizontal disposition by means of a simple drive mechanism.

### SUMMARY OF THE INVENTION

According to one aspect of the present invention, a transport system for advancing containers, in particular an airport baggage handling system, comprises an infeed conveyor defining a transport plane, an ouffeed conveyor disposed at an angle relative to the infeed conveyor, a corner transfer unit placed between the infeed and outfeed conveyors for transferring a container from the infeed conveyor to the outfeed conveyor, wherein the corner transfer unit has a transfer conveyor extending in transport direction of the ouffeed conveyor and defined by a transport plane which is lower than the transport plane of the infeed conveyor, and at least one endless primary conveyor belt disposed in an area of the transfer conveyor and having an upper conveyor run moving in the transport direction of the infeed conveyor, with the primary conveyor belt being routed about a belt-reversing member and provided over part of its length with a first thickened area for compensating a distance between the transport planes of the infeed conveyor and the transfer conveyor so as to enable a movement of the container from the infeed conveyor onto the transfer conveyor as the container rests on the thickened area, and at least one movable support element for maintaining the container above the transport plane of the transfer conveyor as the container exits the infeed conveyor to thereby lower the container to a level of the transport plane of the transfer conveyor, wherein the thickened area moves downwards via the belt-reversing member in synchronism with a downward movement of the support element.

The present invention resolves prior art problems by providing a corner transfer unit having a transfer conveyor which moves in transport direction of the ouffeed conveyor. The transfer conveyor may be a roller conveyor, although a configuration as belt conveyor with a pair of spaced-apart conveyor belts is currently preferred. The transport plane of the transfer conveyor is slightly lower than the transport plane of the infeed conveyor. In order to compensate for the slight difference in vertical height between the transport planes of the infeed conveyor and the transfer conveyor, the primary conveyor belt has the first thickened area over a portion of its length, while the portions of the primary conveyor belt without thickened area along its upper conveyor run are positioned below the transport plane of the transfer conveyor. The thickened area is hereby arranged in such a manner that a container can rest on the thickened area and can be advanced from the infeed conveyor to the corner transfer unit. The support element of the corner transfer unit is hereby provided to keep the container in elevated relationship to the transport plane of the transfer conveyor, when leaving the infeed conveyor. The container can be lowered onto the transport plane of the transfer conveyor by guiding the thickened area downwards via the belt-reversing roller into the area of the lower return run of the primary conveyor belt of the corner transfer unit. At a same time, also the support element is lowered.

Reversal of the rotation direction of the drives of the conveyors and conveyor belts results in a reversal of these operations so that the container can be moved in opposite direction as well.

The thickened areas move downwards with the upper conveyor run of the primary conveyor belt of the corner transfer unit into the lower return run and from the return run back again to the conveyor run. In this way, the container can be elevated and lowered simultaneously with the container transport. As a result, the need for a separate drive motor with pertaining mechanics, required otherwise for a horizontal corner transfer, is eliminated. Integration of the lifting and lowering operations into the transverse transport eliminates cycle times for these operations so that the throughput rate is improved. In addition, space can be saved so that the overall unit can be constructed more compact and shallow. Compared to lifting units with slotted guide mechanism, the corner transfer unit according to the invention does not require a time-consuming transverse lifting movement in or opposite to the incoming or outgoing direction which would also complicate a precise positioning of the transported article.

According to another feature of the present invention, the support element may be constructed as an endless secondary conveyor belt with a second thickened area over part of its length for spanning the distance between the transport planes of the transfer conveyor and the primary conveyor belt, with the secondary conveyor belt being disposed adjacent to and propelled in synchronism with the primary conveyor belt, wherein the lengths of the first and second thickened areas and the lengths of the primary and secondary conveyor belts are so sized as to realize a synchronous lowering of the container, as the thickened areas dive down.

According to another feature of the present invention, a common motor may be provided for commonly operating the primary and secondary conveyor belts.

According to another feature of the present invention, the primary and secondary conveyor belts may be commonly routed about the belt-reversing member, such as an upper belt-reversing roller. In this way, a synchronized movement of the conveyor belts is realized, whereby the thickened areas can be guided upwards or downwards depending on the rotation direction.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic plan view of a transport system with a corner transfer unit according to the present invention in cooperation with an infeed conveyor and an outfeed conveyor.

FIG. 2 is a top and side perspective view of the corner transfer unit of FIG. 1;

FIG. 3 is a top and side perspective view, on an enlarged scale, of a detail of the corner transfer unit; and

FIGS. 4a-4d show schematic illustrations of various movement phases of a container during transport from the infeed conveyor onto the corner transfer unit and directional change of the container by the corner transfer unit;

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

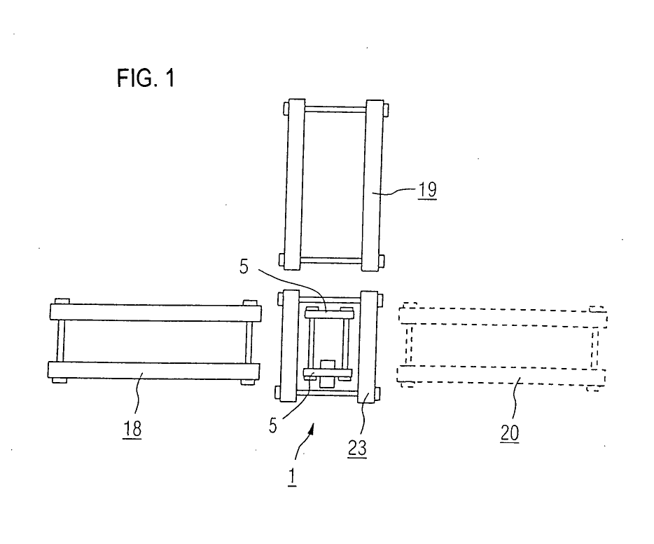

Turning now to the drawing, and in particular to FIG. 1, there is shown a schematic plan view of a transport system with a corner transfer unit according to the present invention, generally designated by reference numeral 1 and disposed between an infeed conveyor 18 and an ouffeed conveyor 19 which are positioned at a right angle to one another. The infeed conveyor 18 and the ouffeed conveyor 19 include each a pair of conveyor belts and are shown here by way of example only. Of course, any type of conveyor, such as e.g. roller conveyors, may be provided for cooperation with the corner transfer unit 1. Depending on the mode of operation and construction of the corner transfer unit 1, articles, such as containers, may be conveyed from the infeed conveyor 18 onto the corner transfer unit 1 and from there further advanced at a right angle to the ouffeed conveyor 19. Of course, the container transport path may also be reversed, i.e. from the conveyor 19 via the corner transfer unit 1 onto the conveyor 18. Conveyor 20, shown here in dashed line, indicates the option to selectively transfer articles, incoming from the conveyor 19, onto the conveyors 18 and 20, which then operate as ouffeed conveyor assembly, while conveyor 19 is then the infeed conveyor.

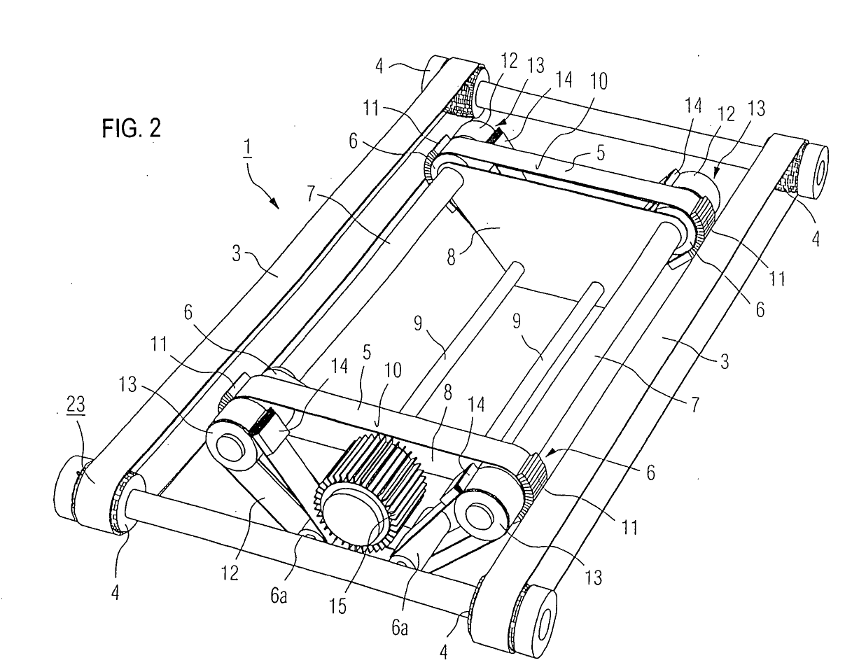

Referring now to FIG. 2, there is shown a top and side perspective view of the corner transfer unit 1 which is useful in particular for an airport baggage handling system. The corner transfer unit 1 includes a transfer conveyor 23 having two outer endless conveyor belts 3 which are driven in synchronism and routed on opposite ends about belt-reversing rollers 4. Disposed between the conveyor belts 3 are two endless conveyor belts 5 which extend in spaced-apart parallel relationship transversely to a transport direction of the conveyor belts 3 and are driven in synchronism. Both inside conveyor belts 5 are routed about upper belt-reversing rollers 6 and lower belt-reversing rollers 6a, with the upper rollers 6 mounted non-rotatably on ends of two parallel shafts 7. The rotatably mounted shafts 7 form together with two end plates 8 and two rod-like carriers 9 a stable carrier frame. The conveyor belts 5 have each an upper conveyor run with a support surface 10, whereby the support surfaces 10 of the conveyor belts 5 extend in a common horizontal plane which is slightly beneath the transport plane as defined by the support surfaces of the conveyor belts 3 of the transfer conveyor 23.

As shown in FIG. 2, the conveyor belts 5 have thickened areas 11, e.g. in the form of elastic rectangular strips, which are glued, molded on or otherwise attached onto the conveyor belts 5 at predetermined distances from one another.

The corner transfer unit 1 is further provided with four shorter secondary conveyor belts 12, two on each side, which are respectively routed about the lower rollers 6a and a belt-reversing roller 13 which seats non-rotatably on the pertaining shaft 7. The secondary conveyor belts 12 are also provided with thickened areas 14 in the form of rectangular elastic strips which can be glued or otherwise attached. The thickness of the thickened areas 11, 14 is selected in such a manner that their top surface bridges the difference in vertical height in relation to the infeed conveyor 18 (FIG. 1), when the thickened areas 11, 14 reach the conveyor run of the conveyor belt 5 or the area of the top side of the roller 13, respectively. The transport plane as defined by the conveyor belts 3 of the transfer conveyor 23 is slightly lower than the transport plane of the infeed conveyor 18 and at the same time in slightly elevated relationship to the plane as defined by the support surfaces 10 of the conveyor belts 5.

The corner transfer unit 1 further includes a single drive motor 15 for driving the inside conveyor belts 5, 12.

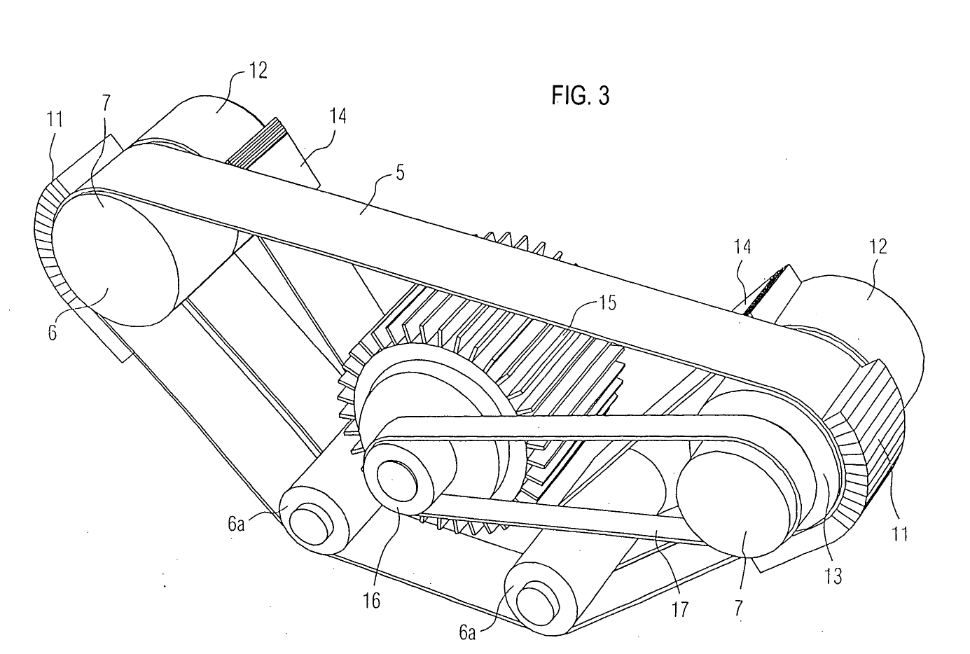

Referring now to FIG. 3, there is shown a top and side perspective view, on an enlarged scale, of a detail of the corner transfer unit 1, in particular of the driving mechanism of the conveyor belts 5, 12 having the thickened areas 11, 14, respectively, shown here adjacent to the rollers 6, 6a, 13. The drive motor 15 has a cylindrical driving wheel 16 which propels one of the shafts 7 through intervention of a belt 17 which is wrapped about the shafts 7.

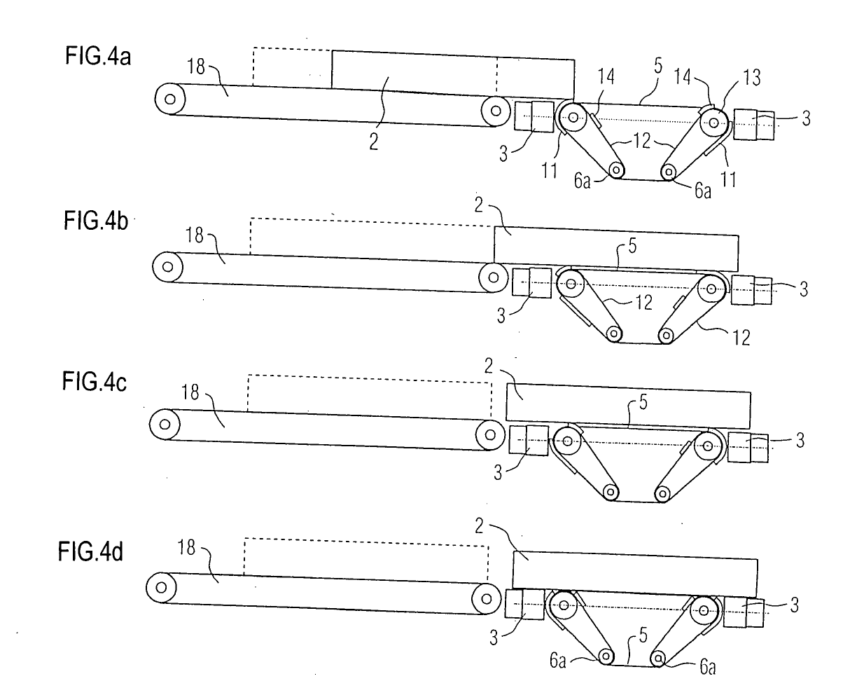

As shown in FIG. 3, the conveyor belts 12 have a same length, whereas the conveyor belt 5 is twice as long as the conveyor belts 12. The length of the thickened areas 11, 14 and in particular their position and distances from one another are so selected as to correspond to the container width and dimensions of the conveyors 18, 19, 20 (i.e. the respective length of the transverse transport) and to ensure a synchronous lowering of the containers 2, when the thickened areas 11, 14 dive down, as will now be described with reference to FIGS. 4a to 4d which illustrate by way of example, various movement phases of a container 2 during transport from the infeed conveyor 18 onto the corner transfer unit 1 and a directional change of the container 2 by the corner transfer unit 1.

FIG. 4a shows the corner transfer unit 1 with the conveyor belts 5, 12 in a first basic position. When a container 2 is moved by the infeed conveyor 18 in the direction of the corner transfer unit 1, the leading edge of the thickened area 11 of the conveyor belt 5 is substantially synchronized with the leading edge of the container 2. As the conveyor belt 5 advances, the thickened area 11 moves at a same speed as the container 2 completely underneath the container 2 to carry the container in the leading container zone. When the trailing edge of the container 2 reaches the end of the infeed conveyor 18, the thickened area 14 of the secondary conveyor belt 12, which is also advanced at same speed, assumes the transfer position and supports the trailing zone of the container 2 as additional support element in order to keep the container 2 in its horizontal disposition in elevated relationship to the transport plane of the conveyor belts 3. This situation is shown in FIG. 4b. As the belt-reversing roller 13 continues to rotate, the thickened areas 11, 14 are moved downwards about the rollers 6, 13 basically at a same time, as shown in FIG. 4c, so that the container is ultimately deposited parallel onto the conveyor belts 3 of the transfer conveyor 23. This situation is shown in FIG. 4d. The corner transfer unit 1 now assumes with its conveyor belts 5, 12 the second basic position in which the support surfaces 10 have a slight distance to the underside of the container 2. Thus, the container 2 can be advanced by the conveyor belts 3 to the ouffeed conveyor 19.

As a consequence of the symmetric disposition of the thickened areas 11, 14 and the length ratio of 1:2 between the conveyor belts 5, 12, the corner transfer unit 1 can be operated in each infeed and ouffeed direction. The container 2 can thus be reversed from the basic position, i.e. from the conveyor belt 3 onto the conveyor belt 5 in order to transfer the container 2 to the conveyors 18 or 20.

Persons skilled in the art will understand that the thickened areas upon the conveyor belts for implementing the lifting and lowering movement during transverse transport by the corner transfer unit may be realized in a manner that is different from the embodiment shown here which represents a currently preferred embodiment. For example, the transverse transport path, implemented by the conveyor belt 5, may also be realized by two or more conveyor belts placed behind one another and formed with thickened areas, with one of the thickened areas assuming the function of the support element.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A transport system for advancing containers, in particular an airport baggage handling system, comprising:
an infeed conveyor defining a transport plane, and an ouffeed conveyor disposed at an angle relative to the infeed conveyor; and
a corner transfer unit placed between the infeed and ouffeed conveyors for transferring a container from the infeed conveyor to the ouffeed conveyor, said corner transfer unit including
a transfer conveyor extending in transport direction of the ouffeed conveyor and defined by a transport plane which is lower than the transport plane of the infeed conveyor,
at least one endless primary conveyor belt disposed in an area of the transfer conveyor and having an upper conveyor run moving in the transport direction of the infeed conveyor, said primary conveyor belt being routed about a belt-reversing member and provided over part of its length with a first thickened area for compensating a distance between the transport planes of the infeed conveyor and the transfer conveyor so as to enable a movement of the container from the infeed conveyor onto the transfer conveyor as the container rests on the thickened area, and at least one movable support element for maintaining the container above the transport plane of the transfer conveyor as the container leaves the infeed conveyor to thereby lower the container to a level of the transport plane of the transfer conveyor, wherein the thickened area moves downwards via the belt-reversing member in synchronism with a downward movement of the support element.

2. The transport system of claim 1, wherein the transfer conveyor and the primary conveyor belt extend at an angle to one another.

3. The transport system of claim 1, wherein the transfer conveyor and the primary conveyor belt extend at a right angle to one another.

4. The transport system of claim 1, wherein the support element is constructed as an endless secondary conveyor belt with a second thickened area over part of its length for compensating the distance between the transport planes of the transfer conveyor and the primary conveyor belt, said secondary conveyor belt being disposed adjacent to and propelled in synchronism with the primary conveyor belt, wherein the first and second thickened areas have a length, with the length of the first and second thickened areas and the length of the primary and secondary conveyor belts being so sized as to realize a synchronous lowering of the container.

5. The transport system of claim 4, and further comprising a motor for commonly operating the primary and secondary conveyor belts.

6. The transport system of claim 4, wherein the primary and secondary conveyor belts are commonly routed about the belt-reversing member.

7. The transport system of claim 6, wherein the belt-reversing member is a belt-reversing roller.

8. The transport system of claim 1, wherein the transfer conveyor is a belt conveyor with two conveyor belts in spaced-apart relationship.

9. The transport system of claim 1, wherein the corner transfer unit includes a second said primary conveyor belt in spaced-apart relationship to the primary conveyor belt.

10. The transport system of claim 9, wherein the transfer conveyor is a belt conveyor with two conveyor belts in spaced-apart relationship, said two primary conveyor belts are disposed in an area between the two conveyor belts of the transfer conveyor.

11. The transport system of claim 1, wherein the transport direction of the infeed and ouffeed conveyors and of the transfer conveyor and the primary conveyor belt are reversible.

12. The transport system of claim 4, wherein the corner transfer unit includes a second said primary conveyor belt in spaced-apart relationship to the primary conveyor belt., said support element including a second said secondary conveyor belt disposed in symmetric relationship to the secondary conveyor belt adjacent to and propelled in synchronism with the second primary conveyor belt.

13. The transport system of claim 4, wherein the length of the primary conveyor belt is twice as long as the length of the secondary conveyor belt.

14. A corner transfer unit for transferring a container between an infeed conveyor and an outfeed conveyor disposed at an angle to one another, comprising:
a first conveyor in alignment with the ouffeed conveyor and having a transport plane which is lower than a transport plane of the infeed conveyor; a second conveyor in alignment with the infeed conveyor and having a transport plane which is lower than the transport plane of the first conveyor, said second conveyor including a thickened area of a size to bridge a vertical distance between the transport plane of the infeed conveyor and the transport plane of the first conveyor and configured to receive an incoming container from the infeed conveyor and deposit it on the first conveyor as the thickened area dives down; and
a support element for supporting a trailing zone of the container during transfer of the container from the infeed conveyor to the first conveyor.

15. The corner transfer unit of claim 14, wherein the first conveyor and the second conveyor extend at an angle to one another.

16. The corner transfer unit of claim 14, wherein the first conveyor and the second conveyor extend at a right angle to one another.

17. The corner transfer unit of claim 14, wherein the support element is disposed adjacent to and propelled in synchronism with the second conveyor.

18. The corner transfer unit of claim 14, and further comprising a motor for commonly operating the second conveyor and the support element.

19. The corner transfer unit of claim 14, wherein the support element includes at least one conveyor belt and the second conveyor includes at least one conveyor belt of a length which is twice as long as the length of the conveyor belt of the support element.

20. The corner transfer unit of claim 14 wherein the first conveyor includes two conveyor belts in spaced-apart relationship, said second conveyor including two conveyor belts disposed in an area between the two conveyor belts of the first conveyor.
